(19) United States
(12) Patent Application Publication
(10) Pub. No.: US 2010/0270818 A1
(43) Pub. Date: Oct. 28, 2010

(54) VEHICULAR MOUNTED INTERIOR NUCLEAR, CHEMICAL & BIOLOGICAL PROTECTION

(75) Inventor: Shane F. Mills, Owego, NY (US)

Correspondence Address: BURNS & LEVINSON, LLP, 125 SUMMER STREET, BOSTON, MA, 02110, US

(73) Assignee: Lockheed Martin Corp., Bethesda, MD (US)

(21) Appl. No.: 11/623,942

(22) Filed: Jan. 17, 2007

Related U.S. Application Data
(60) Provisional application No. 60/759,717, filed on Jan. 18, 2006.

(51) Int. Cl. B60P 3/00; B60H 1/24

(52) U.S. Cl. 296/24.4; 454/70

(57) ABSTRACT

System and method to partition the interior of a vehicle's main crew compartment with retractable or removable walls to form a containment or isolation area at a door or hatch and to form a cab toxic free area elsewhere inside the vehicle's main crew compartment. The containment area is physically cordoned and substantially sealed off from the rest of the vehicle's main crew compartment. Independent HVAC systems controlling the pressure environment of the main crew compartment and the containment area assures that the main crew compartment is maintained at a pressure greater than the containment area as well as the outside environment, thereby isolating the main crew compartment from possible contaminated environments. The containment area's independent HVAC system is equipped with a decontamination/sterilization/filtration system to allow the purification of the air prior to removal or retraction of the removable or retractable partition.

### CROSS REFERENCE TO RELATED APPLICATIONS

This application is based upon provisional patent application Ser. No. 60/759,717 filed Jan. 18, 2006, the benefit of which is claimed and the entire content of which is incorporated herein by reference.

### FIELD OF THE INVENTION

This invention relates generally to vehicle interior environmental protection, and more particularly, to improving the personnel ingress and egress from the vehicle to minimize contamination of the main crew compartment.

### BACKGROUND OF THE INVENTION

Tactical wheeled vehicle ground force crew need the ability to exit a ground vehicle from one door without compromising crew safety due to nuclear, biological, and/or chemical (NBC) exposure. Current vehicle technology does not address the need for crew safety in contaminated or hazardous environments on missions that require crew members to exit and re-enter the vehicle.

The present invention may best be understood from the following detailed description of the embodiments of the invention illustrated in the drawings, wherein:

### BRIEF DESCRIPTION OF THE DRAWINGS

FIG. 1-5 are pictorial illustrations of the present invention installed into a personnel transport vehicle showing the present invention in the deployed (installed or lower) and deployed (removed or retracted) positions; and

FIG. 6 is a schematic diagram of the present invention integrated into a typical personnel transport vehicle HVAC system in accordance with the present invention.

### DETAILED DESCRIPTION OF PREFERRED EMBODIMENTS

The present invention, generally referred to as reference number 10, includes a physical barrier and fluid circulation/purification systems working in concert to isolate a predetermined area of a main crew compartment of a vehicle and to prevent contamination of the remaining areas of the main crew compartment. The physical barrier partitions the interior of a vehicle's main crew compartment with removable or retractable partitions, such as a curtain, to form a containment or isolation area (such as an air lock) near a door or hatch, thereby forming a toxic free area elsewhere inside the vehicle's main crew compartment. The containment area is physically cordoned and sealed off from the rest of the vehicle's main crew compartment. The fluid circulation/purification systems include a separate life support system circuit (discussed in detail below) ducted to the containment area to supply fresh/filtered/air conditioned air into this newly formed space to avoid possible contamination mixing with the main crew compartment air by use of a common duct system. The fluid circulation/purification systems further include an over-pressurization mechanism separately connected to the main crew compartment and the containment area to control migration of contaminant particulates within the vehicle and to control air infiltration from the outside. All crew members will be issued mission-oriented protective postures (MOPP) gear, such as an overgarment, mask/hood, field gear, footwear covers, and gloves. During operation and deployment in an NBC environment, the crew member to be assigned to the containment area will be wearing appropriate MOPP gear.

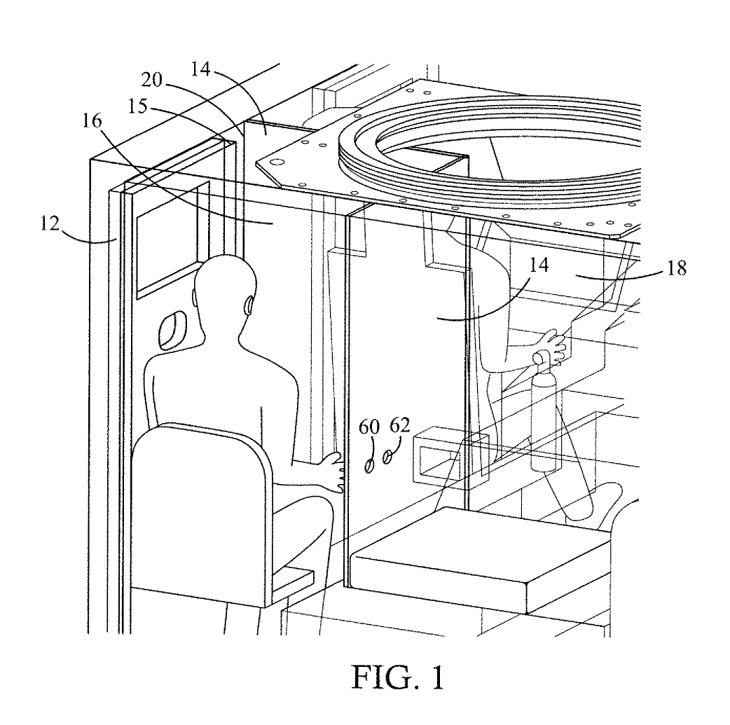

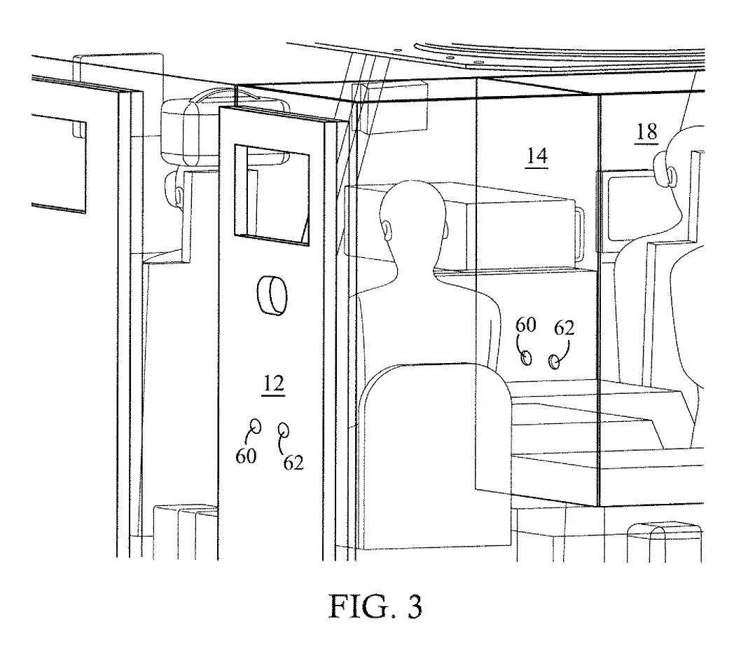

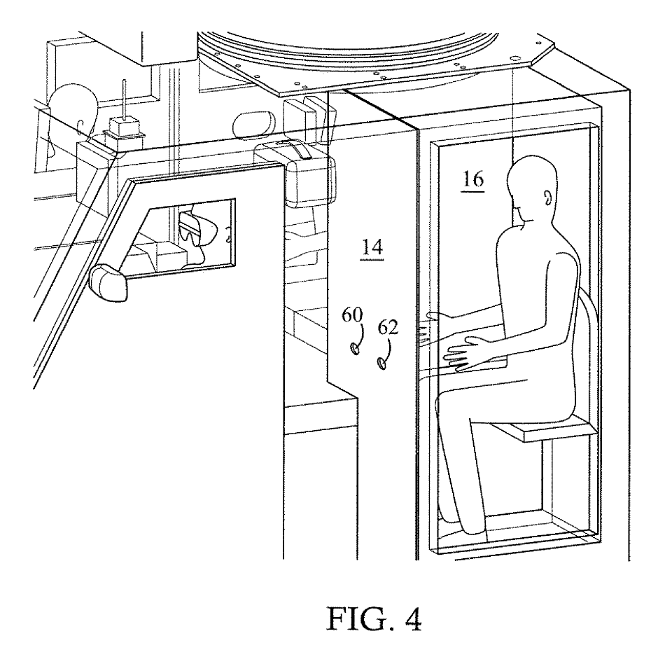

Now turning to FIGS. 1-5, prior to opening an exterior door or hatch 12 (FIGS. 1 and 3), the removable or retractable partition 14 of the present invention 10 will be installed (if partition 14 is detachable) or lowered (if partition 14 is curtain shade type) to deploy and will be secured to an interior surface (such as the ceiling, walls, and/or floors) of the vehicle to substantially seal off the containment area 16 from the remainder for the main crew compartment 18. The sealing of the removable or retractable partition 14 to a surface (such as wall 15) within the vehicle can be a zipper, magnetic strips, hook-and-eye attachments, reusable adhesive, a press-fit interlocking (male/female) engagement mechanism (similar to ZIPLOC®) or another conventional securing mechanism that substantially seals the interfaces 20 (FIG. 1) between the removable or retractable partition 14 and the vehicle interior surfaces (such as wall 15).

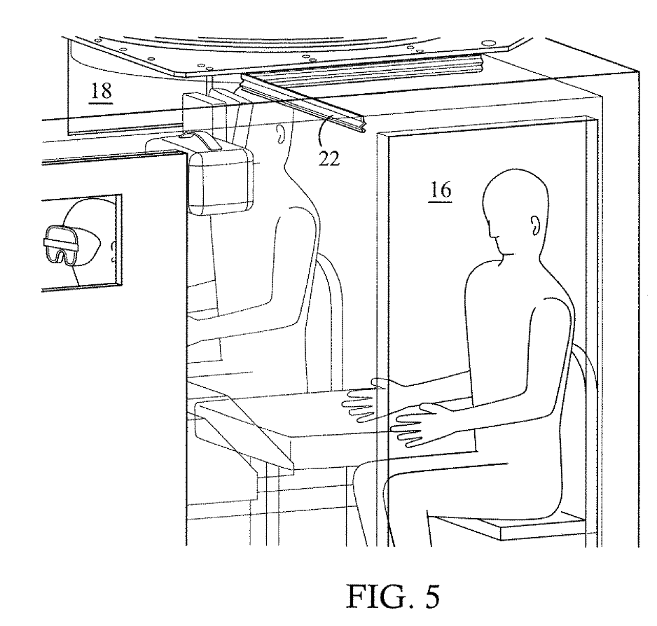

The removable or retractable partition 14 can be made from a material having characteristics that create a substantially impervious barrier impenetrable by contaminant particulates. The material preferably has pores smaller than the pore size of a target contaminant particulate(s). One example of a suitable type of partition material is a plastic, urethane, nylon or other polymer compound. Another example includes the partition material being a woven material (such as polyester and 100% cotton) with nano sized antimicrobial fibers weaved through it that sterilize or decontaminate contaminant particulates on contact. The material can be impregnated, coated, or infused with lead, silver, or other base elements or compounds or chemical antimicrobial additives that will sterilize, decontaminate, block, or otherwise eliminate contaminant particulates. The material should be pliable, flexible, and foldable such that the removable or retractable partition 14 can either be folded into a substantially flat form when detached from the vehicle surfaces and stored in a bag or folded as it is drawn up like a curtain shade into a ganged section 22 along the ceiling of the vehicle (FIG. 5).

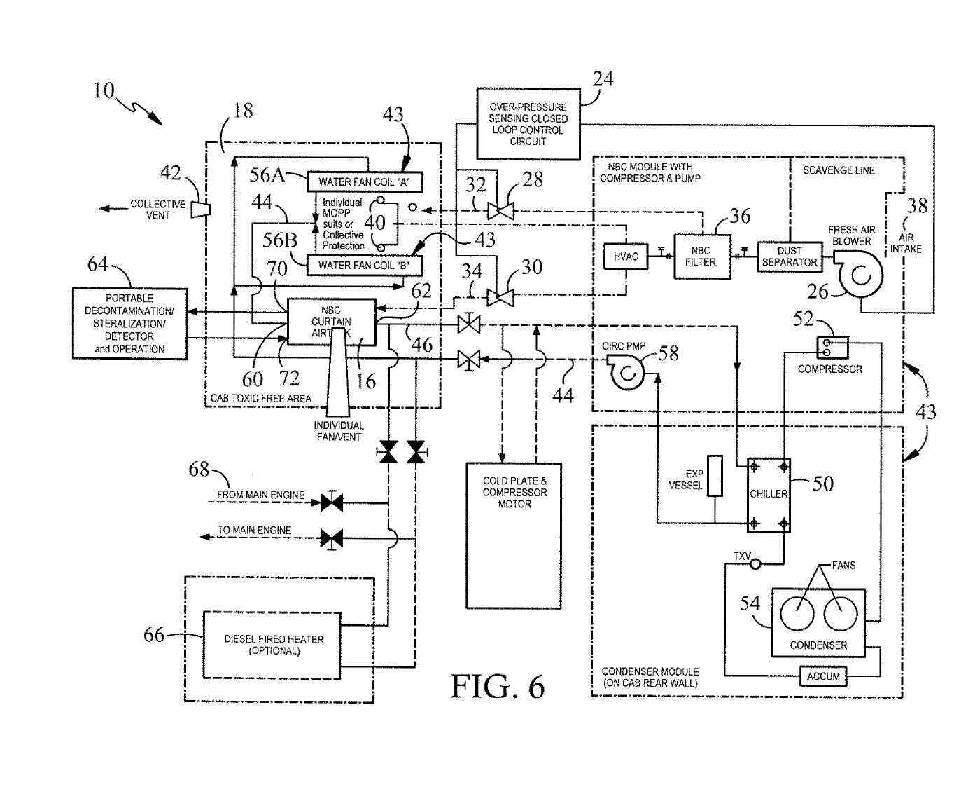

Now turning to FIG. 6, once the removable or retractable partition 14 is in place and sealed, a controller 24 signals fresh air blower 26 to operation at a predetermined flow rate to over-pressurize the crew main compartment 18 and the containment area 16. The over-pressuring in the main crew compartment 18 is regulated by a flow meter or valve 28 in the flow circuit 32 interposed between the fresh air blower 26 and the main crew compartment 18. The over-pressuring in the containment area 16 is regulated by a flow meter or valve 30 in the flow circuit 34 interposed between the fresh air blower 26 and the containment area 16. The over-pressurizing condition provides a positive pressure within the vehicle such that contaminants cannot enter into the vehicle and, particularly, into the protected main crew compartment 18. Positive pressure means that the pressure inside the vehicle is greater than the pressure outside the vehicle or ambient pressure. Positive pressure can also by illustrated as positive delta pressure or pressure differential (□p). Since fluid (such as air) flows from highest to lowest pressure (the path of least resistance), outside or ambient air with contaminant particulates cannot enter the vehicle as long as the pressure within the vehicle (main crew compartment 18 and containment area 16) is greater than ambient pressure.

When operating in the over-pressure mode, the flow circuit 32 for the main crew compartment 18 operates at a predetermined pressure above the pressure in the flow circuit 34 for the containment area 16. This condition creates a pressure differential (□p) between the main crew compartment 18 and the containment area 16 with air flowing or leaking (if any) from the main crew compartment 18 into the containment area 16. Air from containment area 16 cannot enter main crew compartment 18 as long as the pressure within main crew compartment 18 is greater than the pressure within the containment area 16.

In the situation where the removable or retractable partition 14 are perfectly sealed (zero leakage) at the interfaces 20 to a vehicle interior surface (such as walls 15), a pressure differential between main crew compartment 18 and containment area 16 is not necessary. However, a pressure differential is preferred in case the removable or retractable partition 14 is jarred or dislocated from the vehicle surfaces under dynamic, operational conditions or by human accident causing the integrity of the perfect seal to fail and an air leak to develop at the interfaces 20.

The main crew compartment 18 and the containment area 16 have independent HVAC (heating, ventilation, and air conditioning) systems. The main crew compartment HVAC system primarily uses the air ductwork installed by the manufacturer of the vehicle and further augmented with an NBC filter 36 at the fresh air intake 38 to filter contaminants present in the incoming air. Also, hook-ups/connector ports 40 are present to connect the individual MOPP suits with the HVAC system. A collective vent 42 regulates the pressure within the main crew compartment 18 and purges air when the pressure within the main crew compartment 18 exceeds a predetermined maximum value. The predetermined maximum value can be based on a pressure that could cause harm or injury to the crew members within the main crew compartment 18 either for a sustained period of time at a pressure level or a one-time peak pressure or both. The collective vent 42 can be a single vent (shown in FIG. 6) or plurality of vents (not shown) attached to wall 15 creating a flow path from the interior of main crew compartment 18 to the outside or ambient environment. The collective vent 42 includes a one-way valve preventing outside or ambient air for infiltrating the main crew compartment 18. Air ducts serpentined throughout the main crew compartment 18 can be networked and in fluid communication with one or more collective vents 42.

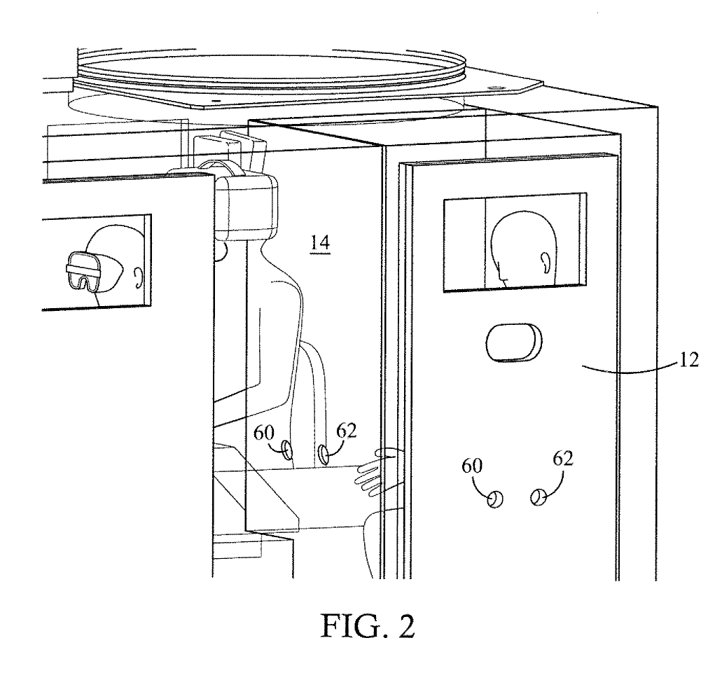

Containment Area HVAC system 43 includes, for example, a chiller 50, compressor 52, water fan coils 56A, 56B, and a circulation pump 58 fluidly interconnected by dedicated recirculation air feed 44 and return ducts 46. The fresh air intake source 38 is the same source as the main crew compartment 18. Once the removable or retractable partition 14 is in place, the containment area HVAC system 43 draws air from the containment area 16. The air is circulated through ducts 44, 46 to condition the air for sustaining human life within the containment area 16. The air feed and return ports 60, 62 can be positioned in the door or hatch 12 (as shown in FIGS. 2 and 3), ceiling, floors, and/or walls 15 of the vehicle with the ductwork integrated into the structure of the vehicle. Alternatively, the air feed and return ports 60, 62 can be placed in the removable or retractable partition 14 (shown in FIGS. 1 and

4). The ports 60, 62 can include one-way valves such that the air feed port 60 opens into the containment area 16 when, for example, a predetermined positive pressure is applied from the main crew compartment side, and the air return port 62 opens into the main crew compartment 18 when, for example, a predetermined negative pressure or vacuum is applied from the main crew compartment side. Also for further precaution, the ports 60, 62 may include a safety lock prohibiting the port from opening until a hose or duct (not shown) were connected to the ports 60, 62 on the main crew compartment side of the removable or retractable partition 14. The hose or duct must be connected at its other end to the HVAC system 43.

The main crew compartment 18 and containment area 16 air may be heated by using a diesel fired heater 66 or heated directly from the vehicle's engine 68 (FIG. 6).

Additionally, a closed-loop portable decontamination/sterilization/detector device 64 can be connected to the containment area 16 at outlet port 70 and inlet port 72 to treat the air after the containment area 16 has been exposed to an NBC environment. Once the air within the containment area 16 has been treated and determined safe, the removable or retractable partition 14 can be removed or retracted and the containment area 16 can be returned to normal operation as part of the main crew compartment 18.

As an additional precaution to the closed-loop decontamination/sterilization/detector device 64 or when the contamination level within the containment area 16 is above safe levels, the vehicle can be driven to the contamination station where the exterior of the vehicle is hosed down with a decontamination solution, such as Decontamination Solution Number Two (DS2). The crew members in the main crew compartment 18 will evacuate the vehicle after the exterior of the vehicle has been decontaminated. Then the crew member in the containment area 16 will evacuate the vehicle and will be hosed down with a decontamination solution. The interior of the containment area 16 will be decontaminated prior to removal or retraction of the removable or retractable partition 14 to avoid or minimize contamination of the main crew compartment 18.

Thus, the present invention provides the Tactical Wheeled vehicle ground force crew with the ability to allow for exiting a ground vehicle from one door without compromising crew safety to loss of nuclear, biological and chemical (NBC) protection. It provides a structure and method of partitioning the interior of a vehicle's cab with an air lock curtain device that is able to be quickly put in place by the person exiting the vehicle. This newly formed compartment is then physically cordoned from the rest of the interior. A separate Life Support System (LSS) circuit routed to this compartment pipes fresh/clean air conditioned air into this newly formed space. The LSS circuits are separate from each other and therefore safe for the rest of the passengers. The crewmember to be birthed has on MOPP gear [Mission Oriented Protective Postures] to handle the NBC environment. Both of the cab compartments are provided with overpressure with conditioned air. This overpressure provides a positive seal against contagens entering the unprotected crew space. The actual sealing surface or method could be a zipper, magnetic strips, Velcro®, or a “zip-lock” type of interface. After the birthing missing is over and that crew member re-enters the vehicle, the crewmember must stay inside the MOPP suit and the air-lock curtain must stay intact until taken to a decontamination station and sprayed down with a DS2 solution.

It is to be understood that the above-described embodiments are simply illustrative of the principles of the invention. Various and other modifications and changes may be made by those skilled in the art which will embody the principles of the invention and fall within the spirit and scope thereof.

1. In a tactical vehicle, the improvement comprising:
a. an interior space which is sealed from the ambient atmosphere;
b. a cab having an entrance located within the interior space;
c. a crew space connected with the cab and located within the interior spacde;
d. a retractable or removable partition forming the cab into an isolation area adjacent to the entrance and which is physically cordoned and substantially sealed off from the crew space;
e. means for providing a greater air pressure in the cab and crew space than in the ambient atmosphere; and
f. a life support system for decontaminating and sterilizing and filtering the isolation area to allow the purification of the air prior to removal or retraction of the removable or retractable partition.

2. The improvement of claim 1 wherein the atmosphere in the crew space is at a higher pressure than the atmosphere in the cab.

3. The improvement of claim 2 wherein there is an independent HVAC system for controlling the environment of the cab and main crew compartment.

4. The improvement of claim 1 wherein the partition is an air lock curtain device constructed and arranged to be quickly put in place.

5. The improvement of claim 4 wherein the life support system is arranged to provide two separate fresh/clean conditioned air for the isolation area and the crew space.

6. The improvement of claim 1 wherein the partition forms the isolation area using a zipper, magnetic strips, Velcro, or a zip-lock type of interface.

7. A method for providing protection to the crew of a vehicle when one member of the crew leaves and/or enters the vehicle, comprising the steps of:
a. providing an interior space which is sealed from the ambient atmosphere;
b. providing a cab having an entrance located within the interior space;
c. providing a crew space, connected with the cab and located within the interior spacde;
d. forming the cab into an isolation area adjacent to the entrance which is physically cordoned and substantially sealed off from the crew space;
e. providing a greater air pressure in the cab and crew space than in the ambient atmosphere; and
f. decontaminating and sterilizing and filtering the isolation area to allow the purification of the air prior to removal or retraction of the removable or retractable partition.

8. The method of claim 7 wherein the atmosphere in the crew space is maintained at a higher pressure than the atmosphere in the cab.

9. The method of claim 8 wherein there is provided an independent HVAC system for controlling the environment of the cab and main crew compartment.

10. The method of claim 7 wherein the partition is an air lock curtain arranged to be quickly put in place.

11. The method of claim 10 wherein the life support system provides two separate fresh/clean conditioned air for the isolation area and the crew space.

12. The method of claim 7 wherein the partition forming the isolation area is a zipper, magnetic strips, Velcro, or a zip-lock type of interface.
